(19) United States
(12) Patent Application Publication
(10) Pub. No.: US 2025/0086114 A1
(43) Pub. Date: Mar. 13, 2025

(54) PERFORMANCE-BASED CACHE ADJUSTMENT

(71) Applicant: QUALCOMM Incorporated, San Diego, CA (US)

(72) Inventors: Karunakar Reddy BASIREDDY, SPSR Nellore (IN); George PATSILARAS, San Diego, CA (US); Vivekanandan NAVEEN, Bangalore (IN)

(21) Appl. No.: 18/466,171

(22) Filed: Sep. 13, 2023

(51) Int. Cl. G06F 12/0871

(52) U.S. Cl. CPC G06F 12/0871

(57) ABSTRACT

A device includes a system cache accessible to a central processing unit (CPU) sub-system. The system cache includes a CPU portion allocated to the CPU sub-system. The device also includes a cache allocation governor that is configured to obtain a performance metric associated with at least one of the system cache or the CPU sub-system. The cache allocation governor is also configured to, based on the performance metric satisfying a cache adjustment criterion, adjust a size of the CPU portion.

### I. FIELD

The present disclosure is generally related to performance-based cache adjustment.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate a system cache that is shared by multiple device components. For example, a portion of the system cache can be assigned for use by a central processing unit (CPU), another portion of the system cache can be assigned for use by a camera, yet another portion of the system cache can be assigned for use by an audio processor, and so on. A smaller CPU portion in the system cache can result in more cache misses. However, indiscriminately increasing the size of the CPU portion can reduce space available for allocation to other components in the system cache.

### III. SUMMARY

According to one implementation of the present disclosure, a device includes a system cache accessible to a central processing unit (CPU) sub-system. The system cache includes a CPU portion allocated to the CPU sub-system. The device also includes a cache allocation governor that is configured to obtain a performance metric associated with at least one of the system cache or the CPU sub-system. The cache allocation governor is also configured to, based on the performance metric satisfying a cache adjustment criterion, adjust a size of the CPU portion.

According to another implementation of the present disclosure, a method includes obtaining, at a device, a performance metric associated with at least one of a system cache or a central processing unit (CPU) sub-system of the device. The method also includes, based on determining that the performance metric satisfies a cache adjustment criterion, adjusting a size of a CPU portion in the system cache. The CPU portion is allocated to the CPU sub-system.

According to another implementation of the present disclosure, a non-transitory computer-readable medium stores instructions that, when executed by one or more processors, cause the one or more processors to obtain a performance metric associated with at least one of a system cache or a central processing unit (CPU) sub-system. The instructions also cause the one or more processors to, based on determining that the performance metric satisfies a cache adjustment criterion, adjust a size of a CPU portion in the system cache. The CPU portion is allocated to the CPU sub-system.

According to another implementation of the present disclosure, an apparatus includes means for obtaining a performance metric associated with at least one of a system cache or a central processing unit (CPU) sub-system. The apparatus also includes means for adjusting a size of a CPU portion in the system cache. The size is adjusted based on determining that the performance metric satisfies a cache adjustment criterion. The CPU portion is allocated to the CPU sub-system.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to conduct performance-based cache adjustment, in accordance with some examples of the present disclosure.

FIG. 2 is a diagram of an illustrative aspect of operations that can be performed by the system of FIG. 1, in accordance with some examples of the present disclosure.

FIG. 3 is a diagram of an illustrative aspect of operations that can be performed by the system of FIG. 1, in accordance with some examples of the present disclosure.

FIG. 4A is a diagram of an illustrative aspect of operations that can be performed by the system of FIG. 1, in accordance with some examples of the present disclosure.

FIG. 4B is a diagram of an illustrative aspect of operations that can be performed by the system of FIG. 1, in accordance with some examples of the present disclosure.

FIG. 5 is a diagram of a particular implementation of a method of performance-based cache adjustment that may be performed by the system of FIG. 1, in accordance with some examples of the present disclosure.

### V. DETAILED DESCRIPTION

Typically, a device includes a system cache that is shared by multiple device sub-systems. For example, a portion of the system cache can be allocated for use by a central processing unit (CPU), another portion of the system cache can be allocated for use by a camera, yet another portion of the system cache can be allocated for use by an audio processor, and so on. A smaller CPU portion in the system cache can result in more cache misses. However, indiscriminately increasing the size of the CPU portion can reduce space available for other sub-systems in the system cache without a significant performance increase of the CPU. In some cases, a larger CPU portion can reduce efficiency and increase data retrieval time.

Systems and methods of performance-based cache adjustment are disclosed. For example, a device includes a system cache, a cache allocation governor, and a performance monitoring unit (PMU). In some examples, the PMU includes a CPU PMU, a cache PMU, or both. The system cache includes a CPU portion that is allocated for use by a CPU of the device.

The PMU monitors performance of the device and generates a performance metric indicating the performance of the device during a sampling period (e.g., a monitoring time period). For example, the CPU PMU monitors performance of the CPU during a sampling period and generates a CPU performance metric (e.g., a count of instructions) indicating the performance of the CPU during the sampling period. As another example, the cache PMU monitors performance of the system cache (e.g., the CPU portion) during the sampling period and generates a cache performance metric (e.g., a count of misses per thousand instructions (MPKI)) indicating the performance of the system cache during the sampling period. The PMU generates a performance metric based on the CPU performance metric, the cache performance metric, or both.

The allocation governor, based on the performance metric, selects an adjustment of the size of the CPU portion and performs the adjustment. The adjustment can correspond to no change in size, an increase in size, or a decrease in size of the CPU portion in the system cache. In some examples, the adjustment corresponds to reverting a prior adjustment. For example, the allocation governor, in response to determining that a prior adjustment was an increase in the size of the CPU portion by a first amount and that the performance metric indicates that the performance did not improve sufficiently during the sampling period, decreases the size of the CPU portion by the first amount to revert the first adjustment.

Decreasing the size of the CPU portion can include deallocating one or more blocks of the system cache. In some examples, a cache controller of the device can power collapse the one or more deallocated blocks to reduce power consumption of the system cache. A technical advantage of the performance-based cache adjustment can include balancing performance improvements with having an efficient allocation of space in the system cache for sub-systems of the device.

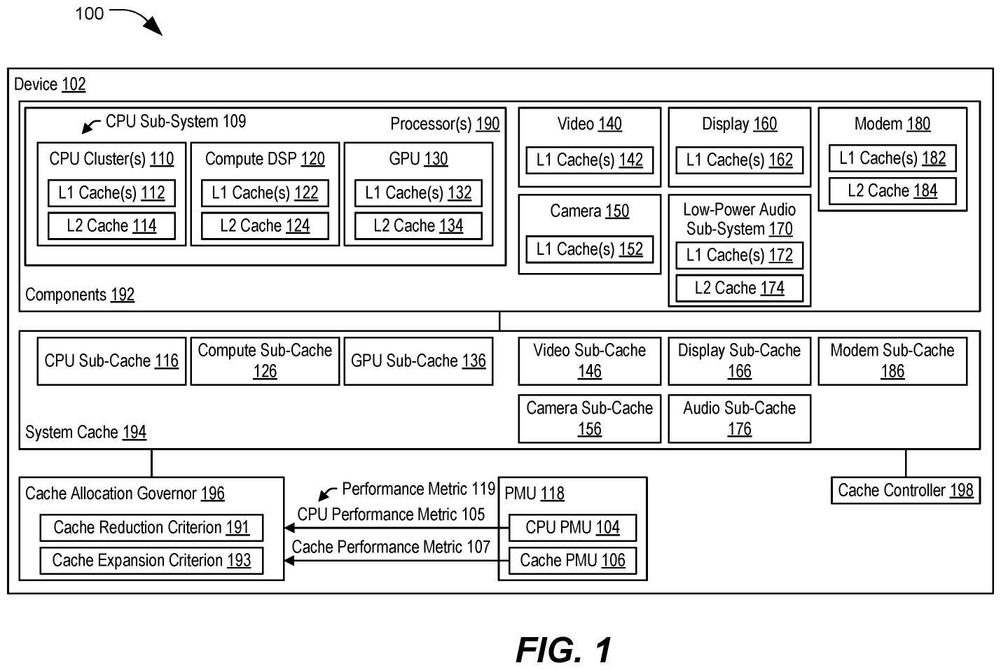

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

As used herein, the terms “comprise.” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first.” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled.” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining.” “calculating.” “estimating.” “shifting.” “adjusting,” etc. may be used to describe how one or more operations are performed. It should be noted that such terms are not to be construed as limiting and other techniques may be utilized to perform similar operations. Additionally, as referred to herein, “generating,” “calculating.” “estimating.” “using.” “selecting.” “accessing.” and “determining” may be used interchangeably. For example, “generating,” “calculating.” “estimating.” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system configured to conduct performance-based cache adjustment is disclosed and generally designated 100. The system 100 includes a device 102 that includes components 192 coupled to a system cache 194. The device 102 also includes a cache allocation governor 196 that is coupled to the system cache 194 and to a performance monitoring unit (PMU) 118. The PMU 118 includes a central processing unit (CPU) PMU 104, a cache PMU 106, or both. The device 102 includes a cache controller 198 coupled to the system cache 194.

In an example, the components 192 include one or more processors 190, a video component 140, a camera 150, a display 160, a low-power audio sub-system 170, a modem 180, one or more additional components, or a combination thereof. The one or more processors 190 include a CPU sub-system 109, a compute digital signal processor (DSP) 120, a graphics processing unit (GPU) 130, one or more additional processing components, or a combination thereof. In an example, the CPU sub-system 109 includes one or more CPU clusters 110. To illustrate, a CPU cluster 110 includes multiple CPU cores. In another example, the CPU sub-system 109 can include a single CPU core.

According to some implementations, one or more of the components 192 include one or more local caches. In an example, the CPU sub-system 109 (e.g., each CPU cluster 110 or CPU core) includes one or more level one (L1) caches 112, the compute DSP 120 includes one or more L1 caches 122, the GPU 130 includes one or more L1 caches 132, the video component 140 includes one or more L1 caches 142, the camera 150 includes one or more L1 caches 152, the display 160 includes one or more L1 caches 162, the low-power audio sub-system 170 includes one or more L1 caches 172, the modem 180 includes one or more L1 caches 182, or a combination thereof.

In some implementations, one or more of the components 192 include hierarchical local caches. For example, the CPU sub-system 109 (e.g., each CPU cluster 110 or CPU core) includes a L2 cache 114, the compute DSP 120 includes a L2 cache 124, the GPU 130 includes a L2 cache 134, the low-power audio sub-system 170 includes a L2 cache 174, the modem 180 includes a L2 cache 184, or a combination thereof.

The system cache 194 is configured to be accessible to one or more of the components 192. For example, the system cache 194 corresponds to a last-level cache (LLC) for one or more of the components 192. Portions of the system cache 194 can be allocated to particular components or sub-systems of the device 102. For example, a CPU sub-cache 116, a compute sub-cache 126, a GPU sub-cache 136, a video sub-cache 146, a camera sub-cache 156, a display sub-cache 166, an audio sub-cache 176, and a modem sub-cache 186 correspond to portions of the system cache 194 allocated to the CPU sub-system 109, the compute DSP 120, the GPU 130, the video component 140, the camera 150, the display 160, the low-power audio sub-system 170, and the modem 180, respectively. The system cache 194 including the CPU sub-cache 116, the compute sub-cache 126, the GPU sub-cache 136, the video sub-cache 146, the camera sub-cache 156, the display sub-cache 166, the audio sub-cache 176, and the modem sub-cache 186 is provided as an illustrative example, in other examples the system cache 194 can include fewer, additional, or different sub-caches.

The PMU 118 is configured to monitor performance of the device 102 during sampling periods and to generate performance metrics 119 indicating the performance of the device 102 during the sampling periods. For example, the CPU PMU 104 is configured to monitor performance of the CPU sub-system 109 and to generate CPU performance metrics 105 indicating the performance of the CPU sub-system 109 during the sampling periods. As another example, the cache PMU 106 is configured to monitor performance of the system cache 194 (e.g., the CPU sub-cache 116) and to generate cache performance metrics 107 indicating the performance of the system cache 194 during the sampling periods. The PMU 118 is configured to generate a performance metric 119 for a sampling period based on the CPU performance metric 105, the cache performance metric 107, or both, of the sampling period.

The cache allocation governor 196 is configured to, based on determining that a performance metric 119 satisfies a cache adjustment criterion, selectively adjust a size of the CPU sub-cache 116. For example, the cache allocation governor 196 is configured to reduce a size of the CPU sub-cache 116 based on determining that the performance metric 119 satisfies a cache reduction criterion 191. As another example, the cache allocation governor 196 is configured to increase the size of the CPU sub-cache 116 based on determining that the performance metric 119 satisfies a cache expansion criterion 193. In yet another example, the cache allocation governor 196 is configured to refrain from changing the size of the CPU sub-cache 116 based on determining that the performance metric 119 fails to satisfy each of the cache expansion criterion 193 and the cache reduction criterion 191.

In some implementations, the cache allocation governor 196 (or another component of the device 102, such as a memory manager) is configured to deallocate one or more blocks (e.g., memory regions) of the system cache 194 that are no longer assigned for use of the CPU sub-system 109 when the size of the CPU sub-cache 116 is reduced by the cache allocation governor 196. In some of these implementations, the cache controller 198 is configured to power collapse the one or more deallocated blocks to conserve power at the device 102.

In some implementations, the device 102 corresponds to or is included in one of various types of devices. In an illustrative example, the components 192, the system cache 194, the cache allocation governor 196, the PMU 118, the cache controller 198, or a combination thereof, are integrated in a headset device, a mobile phone, a tablet computer device, a wearable electronic device, a voice-controlled speaker system, a camera device, a virtual reality headset, a mixed reality headset, an augmented reality headset, an extended reality headset, a vehicle, a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a navigation device, a headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In some implementations, the device 102 includes memory (e.g., a non-transitory storage medium) that stores instructions, that are executable by one or more processors to implement the functionality described with reference to the cache allocation governor 196, the PMU 118, the CPU PMU 104, the cache PMU 106, the cache controller 198, or a combination thereof. In a particular implementation, the device 102 may be included in a system-in-package or system-on-chip device.

During operation, the PMU 118 monitors performance of the device 102 during a first sampling period (e.g., a first time period) and generates a performance metric 119 indicating the performance of the device 102 during the first sampling period. For example, the CPU PMU 104 monitors performance of the CPU sub-system 109 during the first sampling period and generates a CPU performance metric 105 indicating the performance of the CPU sub-system 109 during the first sampling period. To illustrate, the CPU performance metric 105 indicates a count of instructions performed (e.g., executed) at the CPU sub-system 109 during the first sampling period.

In an example, the cache PMU 106 monitors performance of the system cache 194 (e.g., the CPU sub-cache 116) during the first sampling period and generates a cache performance metric 107 indicating the performance of the system cache 194 during the first sampling period. To illustrate, the cache performance metric 107 indicates a count of hits, a count of misses, a count of memory accesses, a bus bandwidth, a memory bandwidth, a count of allocated blocks, a count of unallocated blocks, a count of active blocks, or a combination thereof, during the first sampling period.

In a particular aspect, the performance metric 119 is based on the CPU performance metric 105, the cache performance metric 107, or both. According to some implementations, the performance metric 119 includes at least one of a count of misses per thousand instructions (MPKI), a miss rate, cycles per instruction (CPI), a count of branch mispredictions, or a count of active cores.

In an example, the CPU performance metric 105 indicates the CPI, where CPI=a count of clock cycles/a count of instructions. In an example, the CPU performance metric 105 indicates the count of active cores. In an example, the cache performance metric 107 indicates the count of branch mispredictions.

In an example, the performance metric 119 includes MPKI, where MPKI=a count of misses/(a count of instructions/1000), the cache performance metric 107 indicates the count of misses, and the CPU performance metric 105 indicates the count of instructions. In an example, the performance metric 119 includes a miss rate, where miss rate=a count of misses/a count of instructions, the cache performance metric 107 indicates the count of misses, and the CPU performance metric 105 indicates the count of instructions.

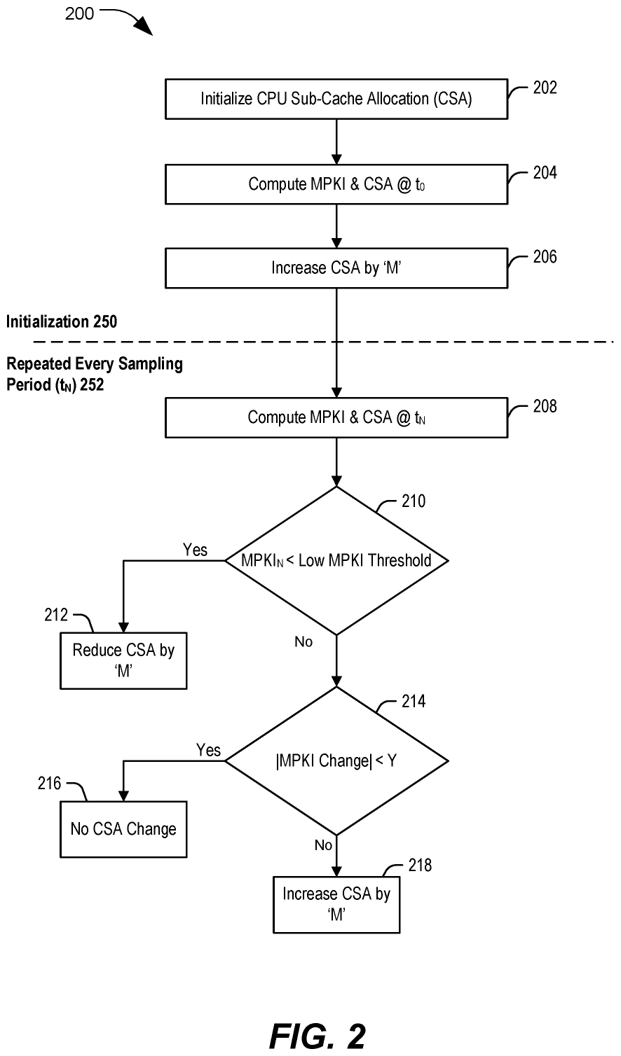

The cache allocation governor 196 selectively adjusts a size of the CPU sub-cache 116 based on the performance metric 119, as further described with reference to FIGS. 2-4B. For example, the cache allocation governor 196, in response to determining that the performance metric 119 satisfies a cache reduction criterion 191, decreases a size of the CPU sub-cache 116. In another example, the cache allocation governor 196, in response to determining that the performance metric 119 satisfies a cache expansion criterion 193, increases the size of the CPU sub-cache 116. Alternatively, the cache allocation governor 196, in response to determining that the performance metric 119 does not satisfy either of the cache reduction criterion 191 or the cache expansion criterion 193, refrains from adjusting the size of the CPU sub-cache 116.

In some implementations, when the cache allocation governor 196 reduces the size of the CPU sub-cache 116, the cache allocation governor 196 (or a memory manager) deallocates one or more blocks of the system cache 194 that were previously assigned to the CPU sub-cache 116. In some of these implementations, the cache controller 198 power collapses the one or more deallocated blocks to conserve power at the system cache 194.

The system 100 thus enables dynamically adjusting the size of the CPU sub-cache 116 based on the performance metric 119. A technical advantage of the dynamic size adjustment can include balancing improved performance (e.g., lower MPKI) due to increase in the size of the CPU sub-cache 116 with reduced power consumption (e.g., by power collapsing deallocated blocks).

Referring to FIG. 2, a diagram 200 is shown of an illustrative aspect of operations that can be performed by the system 100 of FIG. 1, in accordance with some examples of the present disclosure. In a particular aspect, one or more operations of the diagram 200 can be performed by the PMU 118, the CPU PMU 104, the cache PMU 106, the cache allocation governor 196, or a combination thereof.

The diagram 200 illustrates an example of one or more operations that are performed during an initialization phase 250 and an example of one or more operations that are performed during each sampling period phase 252 subsequent to the initialization phase 250. During the initialization phase 250, the cache allocation governor 196, at block 202, initializes the CPU sub-cache allocation (CSA). For example, the cache allocation governor 196 initializes the CPU sub-cache 116 to have an initialization size (e.g., 0). In some aspects, the initialization size is based on a configuration setting, default data, a user input, or a combination thereof.

The cache allocation governor 196, at block 204, obtains the performance metric 119 (e.g., MPKI) and the size of the CPU sub-cache 116 of an initialization sampling period (t₀). For example, the cache allocation governor 196 determines that the CPU sub-cache 116 has the initialization size (e.g., 0) during the initialization sampling period (t₀) and obtains an initialization sampling period performance metric 119 (e.g., MPKI) from the PMU 118 indicating the performance of the device 102 during the initialization sampling period (t₀). In some implementations, a higher value of the performance metric 119 indicates a lower performance of the device 102. The cache allocation governor 196, at block 206, increases the size of the CPU sub-cache 116 (e.g., CSA) by a first amount (M).

During a sampling period phase 252, the cache allocation governor 196, at block 208, obtains an Nth sampling period performance metric 119 (e.g., MPKI) and a size of the CPU sub-cache 116 of an Nth sampling period (t_{N}), where N is a positive integer indicating a temporal position of a sampling period in a sequence of sampling periods. In an example, the cache allocation governor 196 determines that the CPU sub-cache 116 has a first size (e.g., initialization size+M) during a first sampling period (t₁) that is subsequent to the initialization sampling period (t₀) and obtains a first sampling period performance metric 119 (e.g., MPKI) from the PMU 118 indicating the performance of the device 102 during the first sampling period (t₁).

The cache allocation governor 196, at block 210, determines whether the Nth sampling period performance metric 119 is less than a first performance threshold (e.g., a low MPKI threshold). In an example, the cache allocation governor 196 determines whether the first sampling period performance metric 119 is less than the first performance threshold (e.g., the low MPKI threshold).

In some aspects, one or more thresholds are used for comparison with a value based on a performance metric 119 to determine whether the cache reduction criterion 191 or the cache expansion criterion 193 are satisfied. In some aspects, the one or more thresholds are based on default data, a configuration setting, a user input, or a combination thereof.

At block 212, the cache allocation governor 196, in response to determining that the Nth sampling period performance metric 119 is less than the first performance threshold (e.g., low MPKI threshold), determines that the Nth sampling period performance metric 119 satisfies the cache reduction criterion 191 and reduces the size of the CPU sub-cache 116 by the first amount (M). In an example, the cache allocation governor 196 determines that the first sampling period performance metric 119 satisfies the cache reduction criterion 191 based on detecting that the first sampling period performance metric 119 is less than the first performance threshold and reverts the size of the CPU sub-cache 116 to the initialization size.

In some aspects, the Nth sampling period performance metric 119 (e.g., MPKI) less than the first performance threshold indicates that the performance of the device 102 during the Nth sampling period (IN) is better than tolerable and the cache allocation governor 196 reduces the size of the CPU sub-cache 116 to test whether the performance, with any resulting reduction, in a subsequent sampling period (t_{N+1}) will remain tolerable.

Alternatively, the cache allocation governor 196, in response to determining that the Nth sampling period performance metric 119 is greater than or equal to the first performance threshold, at block 210, determines whether a difference in the performance metric 119 is less than a second performance threshold (Y), at block 214. In an example, the cache allocation governor 196 determines the difference in the performance metric 119 (e.g., |MPKI_{N-1}-MPKI_{N}|) based on a comparison of (e.g., an absolute difference between) a previous (N−1) sampling period performance metric 119 (e.g., MPKI_{N-1}) and the Nth sampling period performance metric 119 (e.g., MPKI_{N}). To illustrate, the cache allocation governor 196 determines a difference in the performance metric 119 based on a comparison of (e.g., an absolute difference) between the initialization sampling period performance metric 119 and the first sampling period performance metric 119 (e.g., |MPKI₀-MPKI₁|).

At block 216, the cache allocation governor 196, in response to determining that the difference in the performance metric 119 is less than the second performance threshold (Y), determines that the Nth sampling period performance metric 119 fails to satisfy each of the cache reduction criterion 191 and the cache expansion criterion 193 and refrains from adjusting the size of the CPU sub-cache 116. In an example, the cache allocation governor 196, in response to determining that the change in the performance metric 119 (e.g., |MPKI₀-MPKI₁|) is less than the second performance threshold (Y), determines that the first sampling period performance metric 119 fails to satisfy each of the cache reduction criterion 191 and the cache expansion criterion 193 and refrains from adjusting the size of the CPU sub-cache 116.

In some aspects, the Nth sampling period performance metric 119 is less than the previous (N−1) sampling period performance metric 119 (e.g., MPKI_{N}<MPKI_{N-1}) indicating an improvement in the performance of the device 102. In some of these aspects, the change in the performance metric 119 (e.g., the reduction in MPKI) less than the second performance threshold (Y) (Yes at block 214) indicates that the performance improvement of the device 102 during the Nth sampling period (t_{N}) is insufficient to increase the size of the CPU sub-cache 116 and the cache allocation governor 196 prevents an increase in the size of the CPU sub-cache 116 without detecting a sufficient performance benefit as a result of the prior cache adjustment (e.g., a prior increase).

In some aspects, the Nth sampling period performance metric 119 is equal to the previous (N−1) sampling period performance metric 119 (e.g., MPKI_{N}=MPKI_{N-1}) indicating no change in the performance of the device 102. In some of these aspects, the change in the performance metric 119 (e.g., no MPKI change) less than the second performance threshold (Y) (Yes at block 214) indicates no performance benefit of the device 102 during the Nth sampling period (t_{N}) and the cache allocation governor 196 prevents an increase in the size of the CPU sub-cache 116.

In some aspects, the Nth sampling period performance metric 119 is greater than the previous (N−1) sampling period performance metric 119 (e.g., MPKI_{N}>MPKI_{N-1}) indicating a reduction in the performance of the device 102. In these aspects, the change in the performance metric 119 (e.g., increase in MPKI) less than the second performance threshold (Y) (Yes at block 214) indicates that the reduction in performance is tolerable and the cache allocation governor 196 prevents an increase in the size of the CPU sub-cache 116.

Alternatively, at block 218, the cache allocation governor 196, in response to determining that the difference in the performance metric 119 (e.g., |MPKI_{N-1}-MPKI_{N}|) is greater than or equal to the second performance threshold (Y), determines that the Nth sampling period performance metric 119 satisfies the cache expansion criterion 193 and increases the size of the CPU sub-cache 116 (CSA) by the first amount (M). In an example, the cache allocation governor 196, in response to determining that the change in the performance metric 119 (e.g., |MPKI₀-MPKI₁|) is greater than or equal to the second performance threshold (Y), determines that the first sampling period performance metric 119 satisfies the cache expansion criterion 193 and increases the size of the CPU sub-cache 116 by the first amount (M).

In some aspects, the Nth sampling period performance metric 119 is less than the previous (N−1) sampling period performance metric 119 (e.g., MPKI_{N}<MPKI_{N-1}) indicating an improvement in the performance of the device 102. In some of these aspects, the difference in the performance metric 119 (e.g., the reduction in MPKI) greater than or equal to the second performance threshold (Y) (No at block 214) indicates that the performance benefit of the device 102 during the Nth sampling period (t_{N}) is sufficiently large to increase the size of the CPU sub-cache 116.

In some aspects, the Nth sampling period performance metric 119 is greater than the previous (N−1) sampling period performance metric 119 (e.g., MPKI_{N}>MPKI_{N-1}) indicating a reduction in the performance of the device 102. In some of these aspects, the difference in the performance metric 119 (e.g., increase in MPKI) greater than or equal to the second performance threshold (Y) indicates that the reduction in performance is not tolerable and the cache allocation governor 196 increases the size of the CPU sub-cache 116.

The cache allocation governor 196 can thus dynamically adjust a size of the CPU sub-cache 116 based on a performance metric 119 that indicates a performance of the device 102 during a sampling period. A technical advantage of dynamically changing the size of the CPU sub-cache 116 includes dynamically balancing performance and efficiency for changing CPU sub-cache usage.

It should be understood that MPKI is used as an illustrative example of the performance metric 119, in other examples one or more other metrics can be used as the performance metric 119 to determine whether the cache reduction criterion 191 or the cache expansion criterion 193 is satisfied. FIGS. 2-4B provide illustrative examples of operations to determine whether the cache reduction criterion 191 or the cache expansion criterion 193 is satisfied, in other examples the cache allocation governor 196 can perform one or more fewer, additional, or different operations to determine whether the cache reduction criterion 191 or the cache expansion criterion 193 is satisfied.

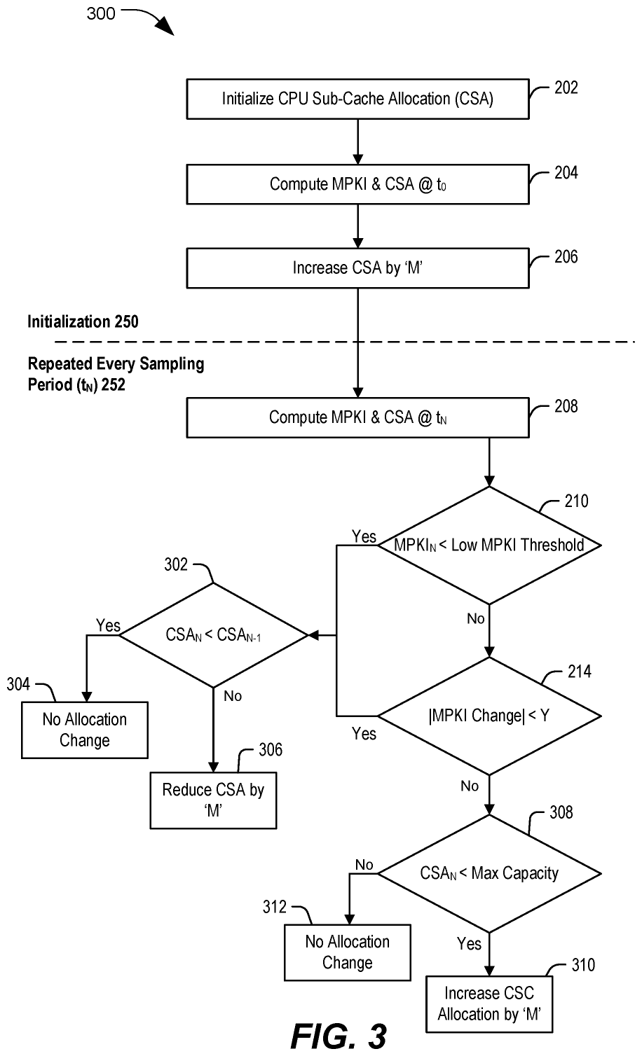

Referring to FIG. 3, a diagram 300 is shown of an illustrative aspect of operations that can be performed by the system 100 of FIG. 1, in accordance with some examples of the present disclosure. In a particular aspect, one or more operations of the diagram 300 can be performed by the PMU 118, the CPU PMU 104, the cache PMU 106, the cache allocation governor 196, or a combination thereof.

The diagram 300 illustrates another example of one or more operations that can be performed during each sampling period phase 252 subsequent to the initialization phase 250. For example, the cache allocation governor 196, in response to determining that the Nth sampling period performance metric 119 is less than the first performance threshold (e.g., low MPKI threshold), at block 210, or determining that a change in the performance metric 119 (e.g., |MPKI_{N-1}-MPKI_{N}|) is less than a second performance threshold (Y), at block 214, determines whether the size of the CPU sub-cache 116 during the Nth sampling period (CSA_{N}) is less than the size of the CPU sub-cache 116 during the previous (N−1) sampling period (CSA_{N-1}), at block 302. For example, the cache allocation governor 196 determines whether the size of CPU sub-cache 116 was reduced between the previous (N−1) sampling period (t_{N-1}) and the Nth sampling period (t_{N}).

At block 304, the cache allocation governor 196, in response to determining that the size of the CPU sub-cache 116 during the Nth sampling period (CSA_{N}) is less than the size of the CPU sub-cache 116 during the previous (N−1) sampling period (CSA_{N-1}), determines that the Nth sampling period performance metric 119 fails to satisfy each of the cache reduction criterion 191 and the cache expansion criterion 193 and refrains from adjusting the size of the CPU sub-cache 116. For example, the cache allocation governor 196, in response to determining that the size of the CPU sub-cache 116 is reduced (e.g., between the previous (N−1) sampling period and the Nth sampling period), refrains from adjusting the size of the CPU sub-cache 116.

Alternatively, at block 306, the cache allocation governor 196, in response to determining that the size of the CPU sub-cache 116 during the Nth sampling period (CSA_{N}) is greater than or equal to the size of the CPU sub-cache 116 during the previous (N−1) sampling period (CSA_{N-1}), determines that the Nth sampling period performance metric 119 satisfies the cache reduction criterion 191 and reduces the size of the CPU sub-cache 116 by the first amount (M). For example, the cache allocation governor 196, in response to determining that the size of the CPU sub-cache 116 is not reduced (e.g., is unchanged or increased between the previous (N−1) sampling period and the Nth sampling period), reduces the size of the CPU sub-cache 116 by the first amount (M).

In some aspects, the Nth sampling period performance metric 119 is less than the first performance threshold (Yes at block 210) indicating that the performance of the device 102 during the Nth sampling period (t_{N}) is better than tolerable. In some of these aspects, if the CPU sub-cache 116 is reduced after the previous (N−1) sampling period (Yes at block 302), the cache allocation governor 196 refrains from reducing the CPU sub-cache 116 (at block 304) after the Nth sampling period (t_{N}). For example, the cache allocation governor 196 waits to see if the next (N+1) sampling period performance metric 119 (e.g., MPKI_{N+1}) remains less than the first performance threshold (indicating that the performance improvement is sustained over at least two sampling periods) to further reduce the size of the CPU sub-cache 116. In some examples, any performance reduction that could have been caused by the prior decrease might be offset by lower usage of the CPU sub-cache 116.

In some aspects, the Nth sampling period performance metric 119 is less than the previous (N−1) sampling period performance metric 119 (e.g., MPKI_{N}<MPKI_{N-1}) indicating an improvement in the performance of the device 102. In some of these aspects, the difference in the performance metric 119 (e.g., the reduction in MPKI) less than the second performance threshold (Y) (Yes at block 214) subsequent to a prior decrease (e.g., CSA_{N}<CSA_{N-1}) in the size of the CPU sub-cache 116 (Yes at block 302) indicates that performance improved subsequent to the prior decrease and the cache allocation governor 196 refrains from further reducing the CPU sub-cache 116 (at block 304) subsequent to the Nth sampling period. For example, the cache allocation governor 196 waits to see if the next (N+1) sampling period performance metric 119 improves further (indicating that the performance improvement is sustained over at least two sampling periods) to further reduce the size of the CPU sub-cache 116.

Alternatively, in some of these aspects, the difference in the performance metric 119 (e.g., the reduction in MPKI) less than the second performance threshold (Y) (Yes at block 214) subsequent to a prior increase (e.g., CSA_{N}>CSA_{N-1}) or no change (e.g., CSA_{N}=CSA_{N-1}) in the size of the CPU sub-cache 116 (No at block 302) indicates that the performance improvement is insufficient and the cache allocation governor 196 reduces the size of the CPU sub-cache 116 (at block 306) by the first amount (M). In an example, the cache allocation governor 196 reduces the size of the CPU sub-cache 116 by the first amount (M) to revert a prior increase in the size of the CPU sub-cache 116.

In some aspects, the Nth sampling period performance metric 119 is equal to the previous (N−1) sampling period performance metric 119 (e.g., MPKI_{N}=MPKI_{N-1}) indicating no change in the performance of the device 102. In some of these aspects, the difference in the performance metric 119 (e.g., no MPKI change) less than the second performance threshold (Y) (Yes at block 214) subsequent to a prior decrease (e.g., CSA_{N}<CSA_{N-1}) in the size of the CPU sub-cache 116 (Yes at block 302) indicates that performance remained the same subsequent to the prior decrease and the cache allocation governor 196 determines that the prior decrease is not to be reverted and refrains from adjusting the size of the CPU sub-cache 116.

Alternatively, the difference in the performance metric 119 (e.g., no MPKI change) less than the second performance threshold (Y) (Yes at block 214) subsequent to a prior increase (e.g., CSA_{N}>CSA_{N-1}) or no change (e.g., CSA_{N}=CSA_{N-1}) in the size of the CPU sub-cache 116 (No at block 302) can indicate that there is no change in performance and the cache allocation governor 196 reduces the size of the CPU sub-cache 116 (at block 306) by the first amount (M). In an example, the cache allocation governor 196 reduces the size of the CPU sub-cache 116 to revert a previous increase in the size of the CPU sub-cache 116.

In some aspects, the Nth sampling period performance metric 119 is greater than the previous (N−1) sampling period performance metric 119 (e.g., MPKI_{N}>MPKI_{N-1}) indicating a reduction in the performance of the device 102. In some of these aspects, the difference in the performance metric 119 (e.g., the increase in MPKI) less than the second performance threshold (Y) (Yes at block 214) subsequent to a prior decrease (e.g., CSA_{N}<CSA_{N-1}) in the size of the CPU sub-cache 116 (Yes at block 302) indicates that the prior decrease caused a tolerable reduction in performance and the cache allocation governor 196 does not revert the prior decrease and refrains from adjusting the size of the CPU sub-cache 116.

Alternatively, in some of these aspects, the difference in the performance metric 119 (e.g., the increase in MPKI) less than the second performance threshold (Y) (Yes at block 214) subsequent to a prior increase (e.g., CSA_{N}>CSA_{N-1}) or no change (e.g., CSA_{N}=CSA_{N-1}) in the size of the CPU sub-cache 116 (No at block 302) can indicate a reduction in performance and the cache allocation governor 196 decreases the size of the CPU sub-cache 116 (at block 306). In some examples, the cache allocation governor 196, in response to detecting a reduction in performance, reduces the size of the CPU sub-cache 116 to revert a previous increase.

The cache allocation governor 196, in response to determining that a change in the performance metric 119 (e.g., |MPKI_{N-1}-MPKI_{N}|) is greater than or equal to the second performance threshold (Y), at block 214, determines whether the size of the CPU sub-cache 116 during the Nth sampling period (CSA_{N}) is less than a maximum capacity, at block 308. In an example, the cache allocation governor 196, in response to determining that the system cache 194 has available space that can be allocated to the CPU sub-cache 116, determines that the size of the CPU sub-cache 116 (CSA_{N}) is less than the maximum capacity.

At block 310, the cache allocation governor 196, in response to determining that the size of the CPU sub-cache 116 (CSA_{N}) is less than the maximum capacity, determines that the Nth sampling period performance metric 119 satisfies the cache expansion criterion 193 and increases the size of the CPU sub-cache 116 by the first amount (M).

Alternatively, at block 312, the cache allocation governor 196, in response to determining that the CPU sub-cache 116 (CSA_{N}) is at maximum capacity, determines that the Nth sampling period performance metric 119 fails to satisfy the cache expansion criterion 193 and refrains from adjusting the size of the CPU sub-cache 116.

In some aspects, the Nth sampling period performance metric 119 is less than the previous (N−1) sampling period performance metric 119 (e.g., MPKI_{N}<MPKI_{N-1}) indicating an improvement in the performance of the device 102. In some of these aspects, the difference in the performance metric 119 (e.g., the reduction in MPKI) greater than or equal to the second performance threshold (Y) (No at block 214) indicates a sufficient improvement in performance corresponding to any previous adjustment and the cache allocation governor 196 increases the size of the CPU sub-cache 116 if the size of the CPU sub-cache 116 has not reached maximum capacity to further improve performance.

In some aspects, the Nth sampling period performance metric 119 is greater than the previous (N−1) sampling period performance metric 119 (e.g., MPKI_{N}>MPKI_{N-1}) indicating a reduction in the performance of the device 102. In some of these aspects, the difference in the performance metric 119 (e.g., the increase in MPKI) greater than or equal to the second performance threshold (Y) (No at block 214) indicates that the reduction in performance is not tolerable and the cache allocation governor 196 increases the size of the CPU sub-cache 116 if the size of the CPU sub-cache 116 has not reached maximum capacity to improve performance.

The cache allocation governor 196 can thus dynamically adjust a size of the CPU sub-cache 116 based on a performance metric 119 that indicates a performance of the device 102 during a sampling period. A technical advantage of dynamically changing the size of the CPU sub-cache 116 includes dynamically balancing performance and efficiency for changing CPU sub-cache usage. Adjusting based on whether the size of the CPU sub-cache 116 was previously reduced can enable the cache allocation governor 196 to determine whether a performance improvement is sustainable over multiple sampling periods prior to reducing the size of the CPU sub-cache 116.

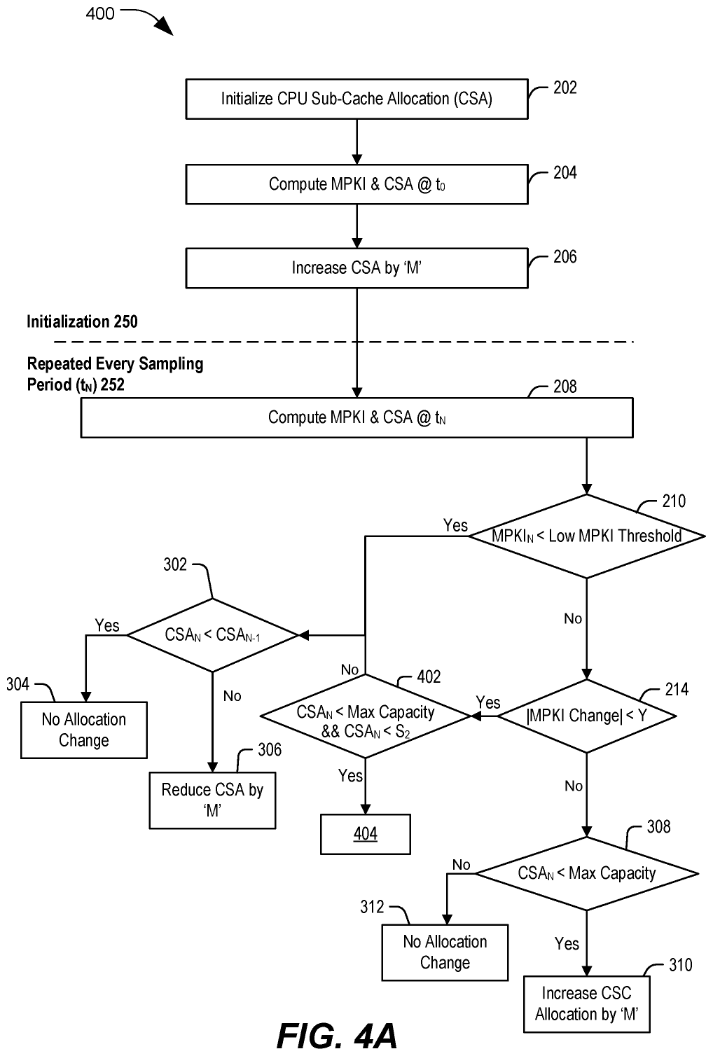

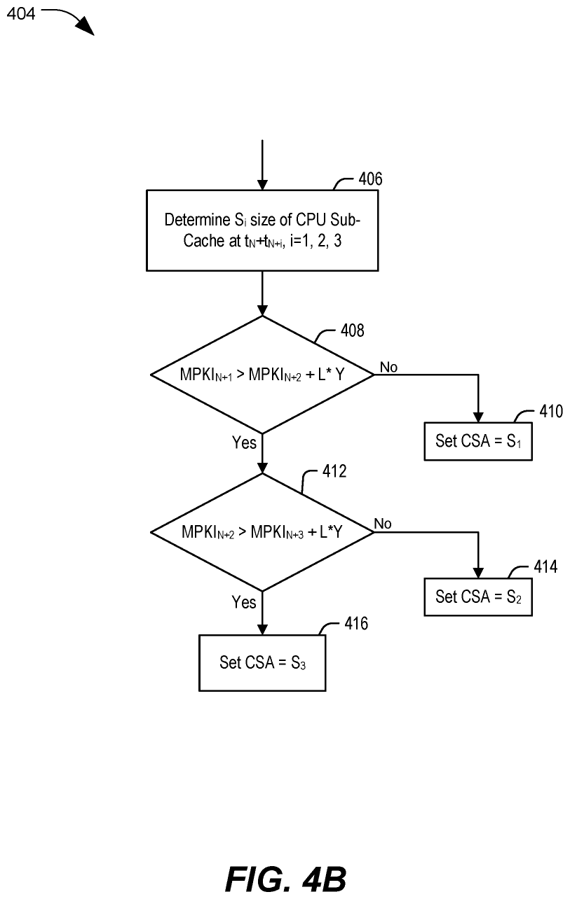

Referring to FIG. 4A, a diagram 400 is shown of an illustrative aspect of operations that can be performed by the system 100 of FIG. 1, in accordance with some examples of the present disclosure. In a particular aspect, one or more operations of the diagram 400 can be performed by the PMU 118, the CPU PMU 104, the cache PMU 106, the cache allocation governor 196, or a combination thereof.

The diagram 400 illustrates another example of one or more operations that can be performed during each sampling period phase 252 subsequent to the initialization phase 250. For example, the cache allocation governor 196, in response to determining that a change in the performance metric 119 (e.g., |MPKI_{N-1}-MPKI_{N}|) is less than a second performance threshold (Y), at block 214, determines whether the size of the CPU sub-cache 116 (CSA_{N}) is less than a maximum capacity and less than a particular size threshold, at block 402. In some aspects, the particular size threshold is based on a second highest particular size (e.g., a second particular size (S₂)) of a plurality of particular sizes, as further described with reference to FIG. 4B.

The cache allocation governor 196, in response to determining that the size of the CPU sub-cache 116 (CSA_{N}) has reached maximum capacity or the particular size threshold, proceeds to perform one or more operations described with reference to block 302 in FIG. 3. For example, the cache allocation governor 196 determines whether the size of the CPU sub-cache 116 is to be reduced or is to remain unchanged. Alternatively, the cache allocation governor 196, in response to determining that the size of the CPU sub-cache 116 (CSA_{N}) is less than maximum capacity and less than the second particular size (S₂), proceeds to perform one or more operations described with reference to block 404 in FIG. 4B. For example, the cache allocation governor 196 determines that the cache expansion criterion 193 is satisfied and increases the size of the CPU sub-cache 116 to a selected one of a plurality of particular sizes. To illustrate, the cache allocation governor 196 tests whether, as a result of at least one of a larger working set size or nonlinear sensitivity to cache size, one or more increased sizes of the CPU sub-cache 116 provide an improved performance benefit.

Referring to FIG. 4B, an example of operations corresponding to block 404 is illustrated. The cache allocation governor 196 determines a plurality of sizes of the CPU sub-cache 116, at block 406. In some implementations, the plurality of sizes includes a first particular size (S₁), the second particular size (S₂), and a third particular size (S₃). The first particular size (S₁) is greater than the size of the CPU sub-cache 116 during the Nth sampling period (CSA_{N}), the second particular size (S₂) is greater than the first particular size (S₁), and the third particular size (S₃) is greater than the second particular size (S₂).

In some implementations, the cache allocation governor 196 determines the plurality of sizes based on space of the system cache 194 that is available to be allocated to the CPU sub-cache 116. For example, the first particular size (S₁) corresponds to a sum of the size of the CPU sub-cache 116 (CSA_{N}) and a first portion (e.g., ¼) of the available space of the system cache 194. As another example, the second particular size (S₂) corresponds to a sum of the size of the CPU sub-cache 116 (CSA_{N}) and a second portion (e.g., ½) of the available space of the system cache 194. As yet another example, the third particular size (S₃) corresponds to a sum of the size of the CPU sub-cache 116 (CSA_{N}) and a third portion (e.g., ¾) of the available space of the system cache 194. The plurality of sizes including three particular sizes is provided as an illustrative example, in other examples the plurality of sizes can include fewer than three particular sizes or more than three particular sizes.

The cache allocation governor 196 sets the size of the CPU sub-cache 116 to the first particular size (S₁) prior to a first subsequent (N+1) sampling period and the PMU 118 generates a first subsequent (N+1) sampling period performance metric 119 indicating a performance of the device 102 during the first subsequent (N+1) sampling period. The cache allocation governor 196 sets the size of the CPU sub-cache 116 to the second particular size (S₂) prior to a second subsequent (N+2) sampling period and the PMU 118 generates a second subsequent (N+2) sampling period performance metric 119 indicating a performance of the device 102 during the second subsequent (N+2) sampling period. The cache allocation governor 196 sets the size of the CPU sub-cache 116 to the third particular size (S₃) prior to the third subsequent (N+3) sampling period, and the PMU 118 generates the third subsequent (N+3) sampling period performance metric 119 indicating a performance of the device 102 during the third subsequent (N+3) sampling period.

The cache allocation governor 196, at block 408, determines whether the first subsequent (N+1) sampling period performance metric 119 (e.g., MPKI_{N+1}) is greater than a sum of the second subsequent (N+2) sampling period performance metric 119 (e.g., MPKI_{N+2}) and a scaled version of the second performance threshold (L*Y). In some implementations, L is a scaling factor with a value between 0 and 1.

In an example, the cache allocation governor 196 determines a first difference (e.g., MPKI_{N+1}-MPKI_{N+2}k) between the first subsequent (N+1) sampling period performance metric 119 and the second subsequent (N+2) sampling period performance metric 119. In some aspects, the first subsequent (N+1) sampling period performance metric 119 (e.g., MPKI_{N+1}) greater than the second subsequent (N+2) sampling period performance metric 119 (e.g., MPKI_{N+2}) indicates a performance improvement in the second subsequent (N+2) sampling period relative to the first subsequent (N+1) sampling period. The cache allocation governor 196 determines whether the first difference (e.g., MPKI_{N+1}-MPKI_{N+2}) is greater than a scaled version of the second performance threshold (L*Y).

The cache allocation governor 196, in response to determining that the first subsequent (N+1) sampling period performance metric 119 (e.g., MPKI_{N+1}) is less than or equal to the sum of the second subsequent (N+2) sampling period performance metric 119 (e.g., MPKI_{N+2}k) and the scaled version of the second performance threshold (L*Y), sets the size of the CPU sub-cache 116 to the first particular size (S₁), at block 410. For example, the cache allocation governor 196, in response to determining that the first difference (e.g., MPKI_{N+1}-MPKI_{N+2}) is less than or equal to the scaled version of the second performance threshold (L*Y), determines an insufficient performance improvement associated with increasing the CPU sub-cache 116 to the second particular size (S₂), and allocates the first particular size (S₁) as the size of the CPU sub-cache 116.

Alternatively, the cache allocation governor 196, in response to determining that the first subsequent (N+1) sampling period performance metric 119 (e.g., MPKI_{N+1}) is greater than the sum of the second subsequent (N+2) sampling period performance metric 119 (e.g., MPKI_{N+2}) and the scaled version of the second performance threshold (L*Y), at block 408, determines whether the second subsequent (N+2) sampling period performance metric 119 (e.g., MPKI_{N+2}) is greater than a sum of the third subsequent (N+3) sampling period performance metric 119 (e.g., MPKI_{N+3}) and the scaled version of the second performance threshold (L*Y), at block 412. In an example, the cache allocation governor 196 determines a second difference (e.g., MPKI_{N+2}-MPKI_{N+3}) between the second subsequent (N+2) sampling period performance metric 119 and the third subsequent (N+3) sampling period performance metric 119. In some aspects, the second subsequent (N+2) sampling period performance metric 119 (e.g., MPKI_{N+2}) greater than the third subsequent (N+3) sampling period performance metric 119 (e.g., MPKI_{N+3}) indicates a performance improvement in the third subsequent (N+3) sampling period relative to the second subsequent (N+2) sampling period. The cache allocation governor 196 determines whether the second difference (e.g., MPKI_{N+2}-MPKI_{N+3}) is greater than the scaled version of the second performance threshold (L*Y).

The cache allocation governor 196, in response to determining that the second subsequent (N+2) sampling period performance metric 119 (e.g., MPKI_{N+2}) is less than or equal to the sum of the third subsequent (N+3) sampling period performance metric 119 (e.g., MPKI_{N+3}) and the scaled version of the second performance threshold (L*Y), sets the size of the CPU sub-cache 116 to the second particular size (S₂), at block 414. For example, the cache allocation governor 196, in response to determining that the second difference (e.g., MPKI_{N+2}-MPKI_{N+3}) is less than or equal to the scaled version of the second performance threshold (L*Y), determines an insufficient performance improvement associated with increasing the CPU sub-cache 116 to the third particular size (S₃), and allocates the second particular size (S₂) as the size of the CPU sub-cache 116.

Alternatively, the cache allocation governor 196, in response to determining that the second subsequent (N+2) sampling period performance metric 119 (e.g., MPKI_{N+2}) is greater than the sum of the third subsequent (N+3) sampling period performance metric 119 (e.g., MPKI_{N+3}) and the scaled version of the second performance threshold (L*Y), allocates the third particular size (S₃) as the size of the CPU sub-cache 116, at block 416. For example, the cache allocation governor 196, in response to determining that the second difference (e.g., MPKI_{N+2}-MPKI_{N+3}) is greater than or equal to the scaled version of the second performance threshold (L*Y), determines that sufficient performance improvement is associated with increasing the size of the CPU sub-cache 116 to the third particular size (S₃), and allocates the third particular size (S₃) as the size of the CPU sub-cache 116.

A technical advantage of testing the performance improvement corresponding to the plurality of particular sizes is determining whether the performance has nonlinear sensitivity to cache size. For example, Nth sampling period performance metric 119 corresponding to an increase in the size of the CPU sub-cache 116 by the first amount (M) may result in an insufficient performance improvement, while a larger cache size (e.g., S₃) may result in a sufficient performance improvement.

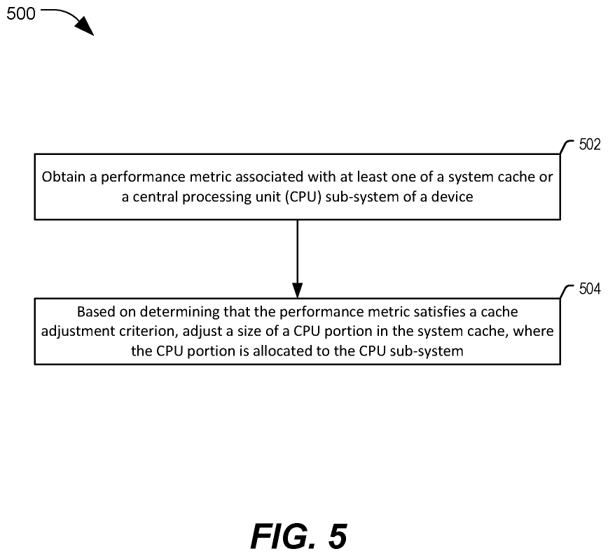

Referring to FIG. 5, a particular implementation of a method 500 of performance-based cache adjustment is shown. In a particular aspect, one or more operations of the method 500 are performed by at least one of the PMU 118, the CPU PMU 104, the cache PMU 106, the cache allocation governor 196, or a combination thereof.

The method 500 includes obtaining a performance metric associated with at least one of a system cache or a central processing unit (CPU) sub-system of a device, at 502. For example, the cache allocation governor 196 obtains the performance metric 119 associated with at least one of the system cache 194 or the CPU sub-system 109, as described with reference to FIG. 1.

The method 500 also includes, based on determining that the performance metric satisfies a cache adjustment criterion, adjusting a size of a CPU portion in the system cache, where the CPU portion is allocated to the CPU sub-system, at 504. For example, the cache allocation governor 196, based on determining that the performance metric 119 satisfies the cache reduction criterion 191 or the cache expansion criterion 193, adjusts a size of the CPU sub-cache 116, as described with reference to FIGS. 1-4B.

In some aspects, adjusting the size of the CPU sub-cache 116 includes reducing the size of the CPU sub-cache 116 and deallocating one or more blocks of the CPU sub-cache 116. In some implementations, the cache controller 198 of FIG. 1 power collapses the one or more deallocated blocks to reduce power consumption of the device 102.

The method 500 thus enables dynamically adjusting the size of the CPU sub-cache 116 based on the performance metric 119. A technical advantage of the dynamic size adjustment can include balancing improved performance (e.g., lower MPKI) due to increase in the size of the CPU sub-cache 116 with reduced power consumption (e.g., by power collapsing deallocated blocks).

The method 500 of FIG. 5 may be implemented by a field-programmable gate array (FPGA) device, an application-specific integrated circuit (ASIC), a processing unit such as a CPU, a DSP, a controller, another hardware device, firmware device, or any combination thereof. As an example, the method 500 of FIG. 5 may be performed by a processor that executes instructions, such as described with reference to FIG. 1.

In conjunction with the described implementations, an apparatus includes means for obtaining a performance metric associated with at least one of a system cache or a central processing unit (CPU) sub-system. For example, the means for obtaining the performance metric can correspond to the PMU 118, the CPU PMU 104, the cache PMU 106, the cache allocation governor 196, the one or more processors 190, the device 102, the system 100 of FIG. 1, one or more other circuits or components configured to obtain the performance metric, or any combination thereof.

The apparatus also includes means for adjusting a size of a CPU portion in the system cache, the size adjusted based on determining that the performance metric satisfies a cache adjustment criterion, where the CPU portion is allocated to the CPU sub-system. For example, the means for adjusting the size can correspond to the cache allocation governor 196, the one or more processors 190, the device 102, the system 100 of FIG. 1, one or more other circuits or components configured to adjust the size of the CPU portion, or any combination thereof.

In some implementations, a non-transitory computer-readable medium (e.g., a computer-readable storage device, such as a memory) includes instructions that, when executed by one or more processors (e.g., the one or more processors 190, the cache allocation governor 196, or a combination thereof), cause the one or more processors to obtain a performance metric (e.g., the performance metric 119) associated with at least one of a system cache (e.g., the system cache 194) or a central processing unit (CPU) sub-system (e.g., the CPU sub-system 109). The instructions, when executed by the one or more processors, also cause the one or more processors to, based on determining that the performance metric satisfies a cache adjustment criterion (e.g., the cache reduction criterion 191 or the cache expansion criterion 193), adjust a size of a CPU portion (e.g., the CPU sub-cache 116) in the system cache, where the CPU portion is allocated to the CPU sub-system.

Particular aspects of the disclosure are described below in sets of interrelated Examples:

According to Example 1, a device includes a system cache and a cache allocation governor. The system cache is accessible to a central processing unit (CPU) sub-system and includes a CPU portion allocated to the CPU sub-system. The cache allocation governor is configured to: obtain a performance metric associated with at least one of the system cache or the CPU sub-system; and adjust a size of the CPU portion based on the performance metric satisfying a cache adjustment criterion.

Example 2 includes the device of Example 1, wherein the cache allocation governor is configured to, based on determining that the performance metric satisfies a cache reduction criterion, decrease the size of the CPU portion, and wherein one or more blocks of the system cache are deallocated responsive to the decrease in the size of the CPU portion.

Example 3 includes the device of Example 2, further comprising a cache controller configured to power collapse the one or more deallocated blocks of the system cache.

Example 4 includes the device of Example 2 or Example 3, wherein the cache allocation governor is configured to determine that the performance metric satisfies the cache reduction criterion based on detecting that the performance metric satisfies a performance threshold.

Example 5 includes the device of any of Examples 1 to 4, wherein the cache allocation governor is configured to, based on determining that the performance metric satisfies a cache expansion criterion, increase the size of the CPU portion.

Example 6 includes the device of Example 5, wherein the cache allocation governor is configured to increase the size of the CPU portion further based on determining that the size of the CPU portion is less than a CPU portion size threshold, that the system cache has available space, or both.

Example 7 includes the device of any of Examples 1 to 6, wherein the cache allocation governor is configured to prevent a second increase of the size of the CPU portion without detecting a performance benefit as a result of a first increase of the size of the CPU portion.

Example 8 includes the device of any of Examples 1 to 7, wherein the cache allocation governor is configured to, based on detecting an insufficient performance benefit as a result of a prior increase of the size of the CPU portion, revert the prior increase of the size of the CPU portion.

Example 9 includes the device of any of Examples 1 to 8, wherein the cache allocation governor is configured to determine a plurality of performance metrics corresponding to a plurality of CPU portion sizes; based on a comparison of the plurality of performance metrics, select a particular CPU portion size from the plurality of CPU portion sizes; and adjust the size of the CPU portion based on the particular CPU portion size.

Example 10 includes the device of any of Examples 1 to 9, wherein the cache allocation governor is configured to, based on detecting that a performance benefit as a result of a prior increase of the size of the CPU portion is less than a performance benefit threshold and to test whether, as a result of at least one of a larger working set size or nonlinear sensitivity to cache size, one or more other CPU portion sizes provide an improved performance benefit: determine a second performance metric corresponding to a second CPU portion size; and based on determining that a difference between the performance metric and the second performance metric is greater than a scaled version of the performance benefit threshold, increase the size of the CPU portion.

Example 11 includes the device of any of Examples 1 to 10, wherein the performance metric includes at least one of a count of misses per thousand instructions (MPKI), a miss rate, cycles per instruction (CPI), a count of branch mispredictions, or a count of active cores.

Example 12 includes the device of any of Examples 1 to 11, wherein the cache allocation governor is configured to obtain a first performance metric from a CPU performance monitoring unit (PMU), the first performance metric indicating a performance of the CPU; and obtain a second performance metric from a cache PMU, the second performance metric indicating a performance of the system cache, wherein the performance metric is based on the first performance metric and the second performance metric.

Example 13 includes the device of Example 12, wherein the performance of the system cache includes a count of hits, a count of misses, a count of memory accesses, a bus bandwidth, a memory bandwidth, a count of allocated blocks, a count of unallocated blocks, a count of active blocks, or a combination thereof.

Example 14 includes the device of Example 12 or Example 13, wherein the performance of the CPU includes a count of instructions.

Example 15 includes the device of any of Examples 1 to 14, wherein the system cache is further accessible to one or more additional sub-systems.

Example 16 includes the device of Example 15, wherein the one or more additional sub-systems include at least one of a graphics processing unit (GPU), a digital signal processor (DSP), an audio processor, a video processor, a modem, a low-power audio sub-system, or a display.

Example 17 includes the device of any of Examples 1 to 16, wherein the system cache includes a last-level cache (LLC).

According to Example 18, a method includes obtaining, at a device, a performance metric associated with at least one of a system cache or a central processing unit (CPU) sub-system of the device; and based on determining that the performance metric satisfies a cache adjustment criterion, adjusting a size of a CPU portion in the system cache, wherein the CPU portion is allocated to the CPU sub-system.

Example 19 includes the method of Example 18, further comprising deallocating one or more blocks of the system cache responsive to a decrease in the size of the CPU portion, wherein the cache adjustment criterion includes a cache reduction criterion, and wherein adjusting the size of the CPU portion includes decreasing the size of the CPU portion.

Example 20 includes the method of Example 19, further comprising power collapsing the one or more deallocated blocks of the system cache.

Example 21 includes the method of Example 19 or Example 20, wherein determining that the performance metric satisfies the cache reduction criterion includes detecting that the performance metric satisfies a performance threshold.

Example 22 includes the method of any of Examples 18 to 21, wherein the cache adjustment criterion includes a cache expansion criterion, and wherein adjusting the size of the CPU portion includes increasing the size of the CPU portion.

Example 23 includes the method of Example 22, wherein the size of the CPU portion is increased further based on determining that the size of the CPU portion is less than a CPU portion size threshold, that the system cache has available space, or both.

Example 24 includes the method of any of Examples 18 to 23, and further includes preventing a second increase of the size of the CPU portion without detecting a performance benefit as a result of a first increase of the size of the CPU portion.

Example 25 includes the method of any of Examples 18 to 24, and further includes, based on detecting an insufficient performance benefit as a result of a prior increase of the size of the CPU portion, reverting the prior increase of the size of the CPU portion.

Example 26 includes the method of any of Examples 18 to 25, further includes determining a plurality of performance metrics corresponding to a plurality of CPU portion sizes; based on a comparison of the plurality of performance metrics, selecting a particular CPU portion size from the plurality of CPU portion sizes; and adjusting the size of the CPU portion based on the particular CPU portion size.

Example 27 includes the method of any of Examples 18 to 26, and further includes, based on detecting that a performance benefit as a result of a prior increase of the size of the CPU portion is less than a performance benefit threshold and to test whether, as a result of at least one of a larger working set size or nonlinear sensitivity to cache size, one or more other CPU portion sizes provide an improved performance benefit: determining a second performance metric corresponding to a second CPU portion size; and based on determining that a difference between the performance metric and the second performance metric is greater than a scaled version of the performance benefit threshold, increasing the size of the CPU portion.

Example 28 includes the method of any of Examples 18 to 27, wherein the performance metric includes at least one of a count of misses per thousand instructions (MPKI), a miss rate, cycles per instruction (CPI), a count of branch mispredictions, or a count of active cores.

Example 29 includes the method of any of Examples 18 to 28, further includes obtaining a first performance metric from a CPU performance monitoring unit (PMU), the first performance metric indicating a performance of the CPU; and obtaining a second performance metric from a cache PMU, the second performance metric indicating a performance of the system cache, wherein the performance metric is based on the first performance metric and the second performance metric.

Example 30 includes the method of Example 29, wherein the performance of the system cache includes a count of hits, a count of misses, a count of memory accesses, a bus bandwidth, a memory bandwidth, a count of allocated blocks, a count of unallocated blocks, a count of active blocks, or a combination thereof.

Example 31 includes the method of Example 29 or Example 30, wherein the performance of the CPU includes a count of instructions.

Example 32 includes the method of any of Examples 18 to 31, wherein the system cache is further accessible to one or more additional sub-systems.

Example 33 includes the method of Example 32, wherein the one or more additional sub-systems include at least one of a graphics processing unit (GPU), a digital signal processor (DSP), an audio processor, a video processor, a modem, a low-power audio sub-system, or a display.

Example 34 includes the method of any of Examples 18 to 33, wherein the system cache includes a last-level cache (LLC).

According to Example 35, a non-transitory computer-readable medium stores instructions that, when executed by a processor, cause the processor to perform the method of any of Example 18 to Example 34.

According to Example 36, an apparatus includes means for carrying out the method of any of Example 18 to Example 34.

According to Example 37, a non-transitory computer-readable medium storing instructions that, when executed by one or more processors, cause the one or more processors to obtain a performance metric associated with at least one of a system cache or a central processing unit (CPU) sub-system; and based on determining that the performance metric satisfies a cache adjustment criterion, adjust a size of a CPU portion in the system cache, wherein the CPU portion is allocated to the CPU sub-system.

According to Example 38, an apparatus includes means for obtaining a performance metric associated with at least one of a system cache or a central processing unit (CPU) sub-system; and means for adjusting a size of a CPU portion in the system cache, the size adjusted based on determining that the performance metric satisfies a cache adjustment criterion, wherein the CPU portion is allocated to the CPU sub-system.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a system cache accessible to a central processing unit (CPU) sub-system, the system cache including a CPU portion allocated to the CPU sub-system; and
a cache allocation governor configured to:
obtain a performance metric associated with at least one of the system cache or the CPU sub-system; and
based on the performance metric satisfying a cache adjustment criterion, adjust a size of the CPU portion.

2. The device of claim 1, wherein the cache allocation governor is configured to, based on determining that the performance metric satisfies a cache reduction criterion, decrease the size of the CPU portion, and wherein one or more blocks of the system cache are deallocated responsive to the decrease in the size of the CPU portion.

3. The device of claim 2, further comprising a cache controller configured to power collapse the one or more deallocated blocks of the system cache.

4. The device of claim 2, wherein the cache allocation governor is configured to determine that the performance metric satisfies the cache reduction criterion based on detecting that the performance metric satisfies a performance threshold.

5. The device of claim 1, wherein the cache allocation governor is configured to, based on determining that the performance metric satisfies a cache expansion criterion, increase the size of the CPU portion.

6. The device of claim 5, wherein the cache allocation governor is configured to increase the size of the CPU portion further based on determining that the size of the CPU portion is less than a CPU portion size threshold, that the system cache has available space, or both.

7. The device of claim 1, wherein the cache allocation governor is configured to prevent a second increase of the size of the CPU portion without detecting a performance benefit as a result of a first increase of the size of the CPU portion.

8. The device of claim 1, wherein the cache allocation governor is configured to, based on detecting an insufficient performance benefit as a result of a prior increase of the size of the CPU portion, revert the prior increase of the size of the CPU portion.

9. The device of claim 1, wherein the cache allocation governor is configured to:
determine a plurality of performance metrics corresponding to a plurality of CPU portion sizes;
based on a comparison of the plurality of performance metrics, select a particular CPU portion size from the plurality of CPU portion sizes; and
adjust the size of the CPU portion based on the particular CPU portion size.

10. The device of claim 1, wherein the cache allocation governor is configured to, based on detecting that a performance benefit as a result of a prior increase of the size of the CPU portion is less than a performance benefit threshold and to test whether, as a result of at least one of a larger working set size or nonlinear sensitivity to cache size, one or more other CPU portion sizes provide an improved performance benefit:
determine a second performance metric corresponding to a second CPU portion size; and
based on determining that a difference between the performance metric and the second performance metric is greater than a scaled version of the performance benefit threshold, increase the size of the CPU portion.

11. The device of claim 1, wherein the performance metric includes at least one of a count of misses per thousand instructions (MPKI), a miss rate, cycles per instruction (CPI), a count of branch mispredictions, or a count of active cores.

12. The device of claim 1, wherein the cache allocation governor is configured to:
obtain a first performance metric from a CPU performance monitoring unit (PMU), the first performance metric indicating a performance of the CPU; and
obtain a second performance metric from a cache PMU, the second performance metric indicating a performance of the system cache,
wherein the performance metric is based on the first performance metric and the second performance metric.

13. The device of claim 12, wherein the performance of the system cache includes a count of hits, a count of misses, a count of memory accesses, a bus bandwidth, a memory bandwidth, a count of allocated blocks, a count of unallocated blocks, a count of active blocks, or a combination thereof.

14. The device of claim 12, wherein the performance of the CPU includes a count of instructions.

15. The device of claim 1, wherein the system cache is further accessible to one or more additional sub-systems.

16. The device of claim 15, wherein the one or more additional sub-systems include at least one of a graphics processing unit (GPU), a digital signal processor (DSP), an audio processor, a video processor, a modem, a low-power audio sub-system, or a display.

17. The device of claim 1, wherein the system cache includes a last-level cache (LLC).

18. A method comprising:
obtaining, at a device, a performance metric associated with at least one of a system cache or a central processing unit (CPU) sub-system of the device; and
based on determining that the performance metric satisfies a cache adjustment criterion, adjusting a size of a CPU portion in the system cache, wherein the CPU portion is allocated to the CPU sub-system.

19. The method of claim 18, further comprising deallocating one or more blocks of the system cache responsive to a decrease in the size of the CPU portion, wherein the cache adjustment criterion includes a cache reduction criterion, and wherein adjusting the size of the CPU portion includes decreasing the size of the CPU portion.

20. The method of claim 19, further comprising power collapsing the one or more deallocated blocks of the system cache.

21. The method of claim 19, wherein determining that the performance metric satisfies the cache reduction criterion includes detecting that the performance metric satisfies a performance threshold.

22. The method of claim 18, wherein the cache adjustment criterion includes a cache expansion criterion, and wherein adjusting the size of the CPU portion includes increasing the size of the CPU portion.

23. The method of claim 22, wherein the size of the CPU portion is increased further based on determining that the size of the CPU portion is less than a CPU portion size threshold, that the system cache has available space, or both.

24. The method of claim 18, further comprising preventing a second increase of the size of the CPU portion without detecting a performance benefit as a result of a first increase of the size of the CPU portion.

25. The method of claim 18, further comprising, based on detecting an insufficient performance benefit as a result of a prior increase of the size of the CPU portion, reverting the prior increase of the size of the CPU portion.

26. The method of claim 18, further comprising:
determining a plurality of performance metrics corresponding to a plurality of CPU portion sizes;
based on a comparison of the plurality of performance metrics, selecting a particular CPU portion size from the plurality of CPU portion sizes; and
adjusting the size of the CPU portion based on the particular CPU portion size.

27. The method of claim 18, further comprising, based on detecting that a performance benefit as a result of a prior increase of the size of the CPU portion is less than a performance benefit threshold and to test whether, as a result of at least one of a larger working set size or nonlinear sensitivity to cache size, one or more other CPU portion sizes provide an improved performance benefit:
determining a second performance metric corresponding to a second CPU portion size; and
based on determining that a difference between the performance metric and the second performance metric is greater than a scaled version of the performance benefit threshold, increasing the size of the CPU portion.

28. The method of claim 18, wherein the performance metric includes at least one of a count of misses per thousand instructions (MPKI), a miss rate, cycles per instruction (CPI), a count of branch mispredictions, or a count of active cores.

29. A non-transitory computer-readable medium storing instructions that, when executed by one or more processors, cause the one or more processors to:
obtain a performance metric associated with at least one of a system cache or a central processing unit (CPU) sub-system; and
based on determining that the performance metric satisfies a cache adjustment criterion, adjust a size of a CPU portion in the system cache, wherein the CPU portion is allocated to the CPU sub-system.

30. An apparatus comprising:
means for obtaining a performance metric associated with at least one of a system cache or a central processing unit (CPU) sub-system; and
means for adjusting a size of a CPU portion in the system cache, the size adjusted based on determining that the performance metric satisfies a cache adjustment criterion, wherein the CPU portion is allocated to the CPU sub-system.
